(19) United States
(12) Patent Application Publication
(10) Pub. No.: US 2002/0162261 A1
(43) Pub. Date: Nov. 7, 2002

(54) Medication identification system

(76) Inventors: Henry L. West, Penfield, NY (US); Suzanne L. West, Chapel Hill, NC (US)

Correspondence Address: Henry L. West, 25 Circle Wood Road, Rochester, NY, 14625, US

(21) Appl. No.: 10/127,799

(22) Filed: Apr. 23, 2002

Related U.S. Application Data
(60) Provisional application No. 60/285,388, filed on Apr. 23, 2001.

(51) Int. Cl. G09F 7/16

(52) U.S. Cl. 40/638; 40/595

(57) ABSTRACT

A specific letter and color visual aid is preprinted on a Medication Profile sheet for each medication. Applying the same visual aid to medication cap and medication container provides a simple “match” medication identification system.

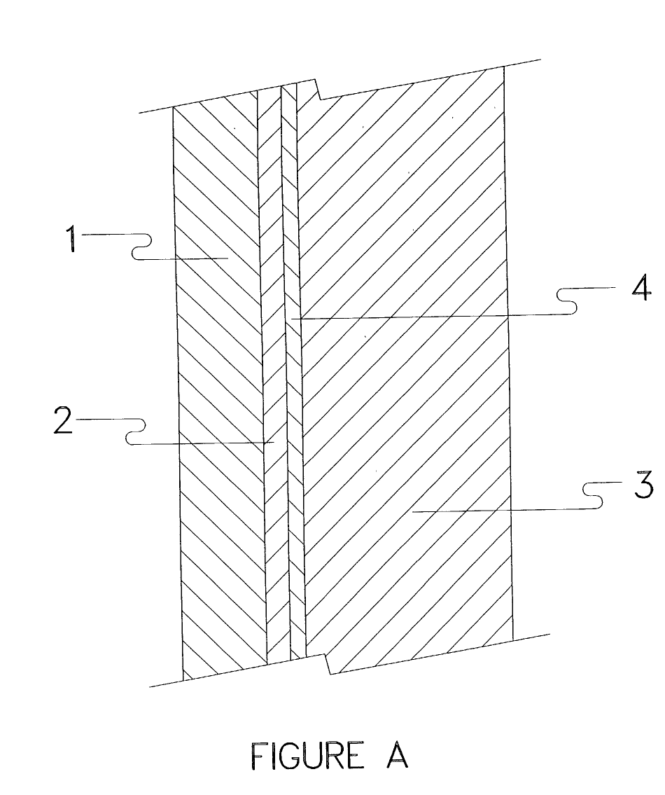

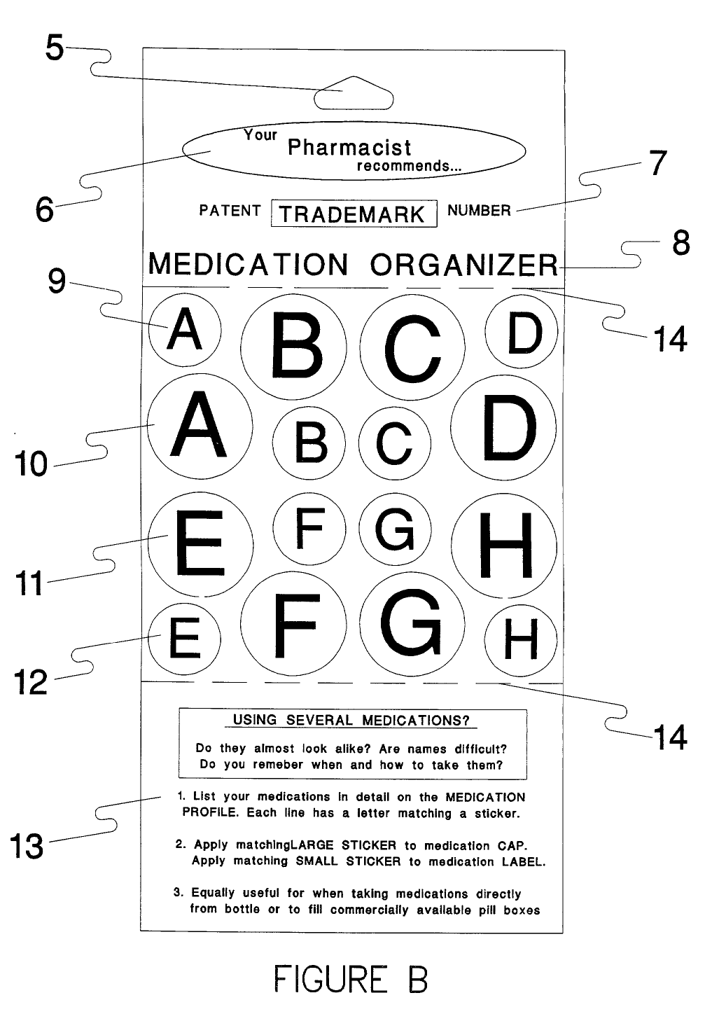

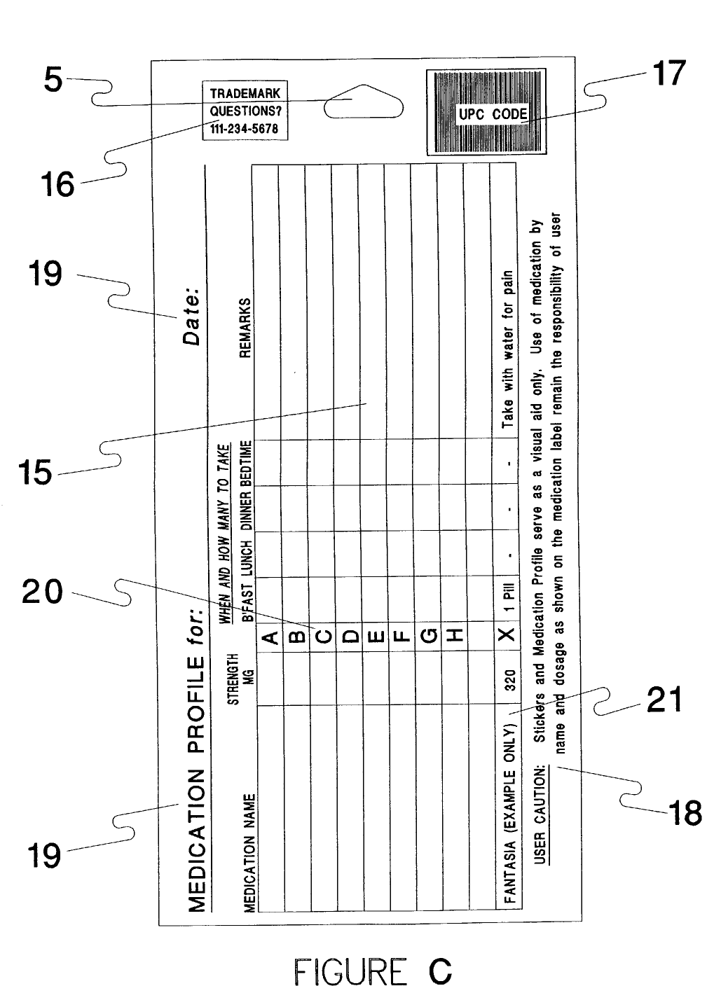

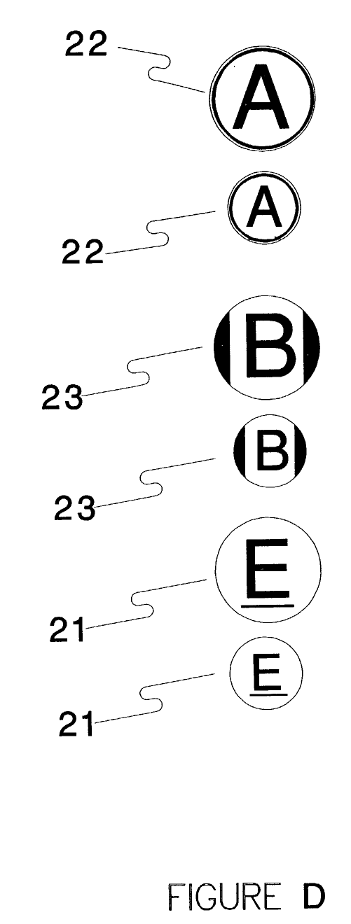

### CROSS REFERENCE TO RELATED APPLICATION

This application claims priority of U.S. provisional Application Serial No. 60/285,388, filed Apr. 23, 2001.

### TECHNICAL FIELD

The invention relates to a medication identification system by means of “match” visual aids primarily intended for patients who take multiple medications.

### BACKGROUND OF INVENTION

Advances in the field of medicine and longer life expectancy of the population have both led to increased use of prescription and non-prescription medications. A recent study by Pfizer Pharmaceutical indicates there are more than 20 million users of “four or more” daily prescription medications in the US. This number increases further if we include non-prescription medications.

For patients using these medications, reading the name on the prescription label or identifying a pill by size, shape or color is not always easy. Also names of medications may be difficult to remember or to distinguish one from the other. Given that nearly half of these patients are elderly intensifies the problem.

A number of devices and aids in the marketplace are intended to make it easy to take medications correctly. Divided pill boxes and matrix listing sheets are simple aids in the common domain. (Ve define a matrix listing as a series of headings such as name of prescription, physician, dosage, when to take, how much to take and so on. Under each heading, generally line by line, the information is entered. The information generally comes from the medication label and the physician's instructions.)

Other systems tend be more complex and costly. We cite divided pill boxes with integral alarm clocks or a recent electronic system to interpret verbally a special bar code in the prescription label (i.e. “talking label”).

One of the more simple aids for the user is described under U.S. Pat. No. 5,995,938 by Whaley. It employs special symbols printed on each medication label and repeats these on a matrix listing of medications. The pharmacist's computer is responsible for generating the data. The symbols serve to replace the fine print on the medication label of how much to take, when to take it, and special info for taking it. It may be difficult for the user to remember and not confuse eight (or more) graphic symbols introduced by the system. Under the Whaley patent, when the patient looks up a medication on the matrix sheet, he then must find the matching medication by looking up the name on the label. Past studies show that medication names can be confusing to patients and are not easily remembered.

### OBJECTS AND ADVANTAGES

It is with this background of existing aids that we have developed a simple “match” visual aid system to make it easier for the patient to identify and therefore take his medication. In its preferred embodiment it is entirely under the patient's or his caregiver's control. (A caregiver is a person who assists the patient in taking his medications).

The object of the invention is to assign a common visual aid identifier field to both the medication container and to the line on the matrix sheet listing that medication. The identifier field can take a number of forms both in shape and content. In the preferred embodiment it consists of consecutive letters (or numbers) each on a color field. The color field can be the same for each letter (or number) or be different and associated with each letter (or number). Numbers and letters of course have been taught to everyone at an early age. The association with color is another well-known mnemonic aid. Thus these “symbols” are very easy to use.

Specifically three elements cooperate to make the invention useful. For the preferred embodiment these are:

(a) A matrix listing, also called Medication Profile. Only headings useful to taking medications are preprinted. (Medication labels generally carry additional information such as the pharmacy's and physician's name, date, refills and so on and may also be used). The user then enters medicine name and requested information line by line in the blank spaces. Each line carries a preprinted letter on a color field. This makes it easy to select a medication by letter and color on the Medication Profile. (Additional blank lines without preprinted letters may also be provided.)

(b) An appropriate number of stickers. These are preferably of the peel-off type and may be combined on a single sheet. Each sticker matches the letter and color of the imprints of the Medication Profile. However their overall size or shape need not be identical. The user applies these stickers to the medication container. Now each medication on the Medication Profile has a matching identifier field on the medication container. This makes it easy for the user to take medications correctly.

(c) Additional duplicate stickers. (They carry the same letter on a color field but need not be identical in overall size or shape). The user applies one sticker to the cap. The cap is most visible and has a large area. The second sticker may be applied to the medication label or elsewhere on the container. Duplicate stickers avoid mix-up when caps of more than one medication have been removed at the same time.

(d) An additional optional refinement may be a way of providing a system for multiple users in a household where the letter and color of the stickers remain essentially the same but carry an additional feature to distinguish between two sets. Alternately additional sets employing further numbers (or letters) may be used.

Advantages of this invention are:

1. The visual “match” linkage between Medication Profile and the Medication container allow quick recognition without reference to difficult medication names.

2. The Medication Profile shows at a glance the total number of medications used.

3. The user can easily verify the correct name of the “B” medication for example by referring to Medication Profile.

4. A user can determine quickly that he needs to take one pill each of medication “A”, “C” and “D” at noon for example by referring to the Medication Profile.

5. The user—when filling divided pill containers—can do so alphabetically. This makes the filling easier.

6. Showing the Medication Profile to the pharmacist or physician allows them to review the medications on a single sheet.

7. A minor change can be made easily on the extra blank lines of the Patient Profile.

8. For a major change a new Medication Profile is needed, but new stickers can be applied over old stickers for medications which are continued.

9. For multiple users in a household, special distinguishing features can be provided between two or more normally identical sets.

Alternates of the embodiment are to combine the Medication Profile and stickers on a common sheet or to combine them using front and back of a single sheet. Another alternate is to provide a refill kit containing several Medication Profile and/or Sticker Sheets. These are useful when obtaining refills of medications or when changing a listing on the Medication Profile sheet.

A further alternate is to generate this information under computer control. It requires special software to which the specific input information is added. The primary physician, pharmacist or patient can take on this responsibility singly or in common. The physician's computer may be linked to the pharmacist's computer or additionally to the user's computer. The pharmacist could print out the Medication Profile and provide the matching stickers to the user or imprint the identifier field directly in the medication label. A variety of variations are possible. The pharmacist may supply medication caps molded with colors and letters. The pharmacist can update the Medication Profile with each change in medication. The user can supply the pharmacist with his preferences for taking the medication (say he prefers to take a single daily pill at noon).

### SUMMARY OF THE INVENTION

Several elements cooperate in this invention.

1. A Medication Profile (also called Patient Profile) listing each medication line-by-line under given headings.

2. An Identification Field is added to each of the above lines with a specific preprinted letter on a colored field as a visual aid.

3. A Sticker Sheet. This sheet provides at least one printed peel-off sticker matching each of the above identification fields. Each sticker is applied to the corresponding Medication Container or Medication Cap and provides a “match” visual aid.

4. A Medication Label with integral “Sticker” matching the corresponding identification field on the Medication Profile can be provided directly on the medication label by the pharmacy's computer.

5. Duplicate Stickers. When the first sticker is applied to the medication cap for best visibility, a second similar sticker is useful somewhere on the container. Duplicate stickers avoid mix-up of two medications when caps have been removed at the same time from more than one container.

6. An optional distinguishing visual feature added to otherwise identical stickers to make it easy to allow additional users within a household.

The preferred embodiment provides the medication profile and stickers on front and back of a single sheet. It allows the user to have control by making all entries and applying the matching stickers himself. However, any arrangement containing a medication profile with identification fields and the repeat of such an identification field on any part of the medication container, medication cap and medication label will satisfy the basic concept of the invention.

Further details of the invention will become clear from the subsequent drawings, description and claims.

### DRAWINGS

The drawings shown refer to the preferred embodiment and show specific details. Alternate arrangements within the scope of the invention are equally applicable and fall within the stated claims.

FIG. A shows a cross-section of the commercial laminated label stock.

FIG. B shows the front face and pertinent details.

FIG. C shows the back face and pertinent details.

FIG. D shows some optional refinements

### DESCRIPTION OF DRAWINGS

We have chosen in the preferred embodiment to combine the Medication Profile and Stickers on a single sheet of commercial laminated label material. We place the stickers on one face (called “front” in the description) and the Medication Profile on the opposite face (called “back” in the description).

FIG. A shows the cross-section of a commercial label laminate, where 1 refers to the printable sticker material, which has a specific thickness (say 3 mils) and an adhesive coating 2 applied to its back. The sticker material is laminated to a backing sheet 3 of a specific thickness (say 6 mils). The backing sheet has a release coating 4 facing the sticker sheet and is printable and writeable on the back face.

The laminate material can be cut to any convenient size. We show a 215 mm×100 mm size. However the invention is not restricted to this size. It can further be die-cut such that each sticker or label on the front face can be peeled-off by the user. It an also can be die-cut with a through-hole of suitable shape to allow placement on a peg of a display rack. It can further be pre-creased to allow folding the sheet to a smaller size if desired.

FIG. B showing the front face or sticker side is divided into several areas, namely top, center and bottom. The top area carries a die-cut hole 5 for placement on a peg of the display rack. The top area has further commercial information such as a name 6, a patent and/or trademark reference 7 and user title 8. Items 5, 6, 7 and 8 are optional and serve to embellish the invention.

The center area shows round peel-off stickers. In the preferred embodiment we show a sticker 9 labeled “A” and printed on a green field and a somewhat smaller sticker 10 labeled “A” and printed on a green field. We also show sticker 11 “B” printed on a yellow field and a similar smaller sticker 12 printed on a yellow field.

The purpose of having duplicate stickers is to place one sticker on the cap of the medication and a matching sticker on the on the prescription container or label. If the user removes several caps at the same time, he will then be able to replace the caps correctly for each medication.

For visual reference we find the cap on the label is the easiest to see and accordingly have made it large. Because the label area tends to be crowded with information, we have chosen a smaller size sticker for the label.

We show eight pairs of stickers—each pair carrying the same letter and color - but the number can vary based on use, but would be still within the scope of the invention.

Also the specific choice of size, shape or color of a sticker is not restricted within the scope of the invention. Also a letter may be replaced by a number or symbol in any language, or can be a combination of letters or symbols. The colored field can also be replaced by any other background field, colored, uncolored or color pattern. While the preferred embodiment uses a letter on a colored field, other combinations achieving a suitable match between a sticker and its corresponding Identification Field would fall within the scope of the invention.

The bottom area carries some user information 13, indicating why and how to use the system. This implementation, while useful, is optional within the scope of the invention. We also show two crease lines 14 which allow folding the sheet to make it smaller if desired.

Optionally we can also apply a background color between the two crease lines 14 to achieve a graphically pleasing contrast.

Figure C shows the back face of the laminate, given over primarily to the Medication Profile 15. Additionally there is the back of the die-cut hole 5 previously discussed under Figure B. The remainder of the area is assigned to additional optional commercial information such as an inquiry area 16, the Universal Product Code 17, and a legal notice 18.

The Medication Profile 15 carries a title line 19 where the user can enter his name and date. This may also be useful if he wishes to review his medications with the physician or pharmacist.

The Medication profile 15 consists of a number of write-in lines where the patient lists each medication by name, strength as furnished, a space each for different times of the day (Breakfast, Lunch, Dinner, Bedtime). The user will enter how much medication he takes, if any, for each of these periods. A “Remark” column is useful for any special instructions under what conditions to take the medication, such as “before eating”, “for pain” and so on.

Each line carries a preprint with letter and colored field 20. This identification field is the key visual aid based on which the matching stickers are applied to the medication. It is this linkage of Medication Profile and Medication Container which provides the simple visual “match” for the user.

We show eight lines for medications, as well as an extra blank line or two. We also show an additional line with an example on how to list medications. The extra lines allow for some addition or correction by the user, but the intent is to replace Medication Profile and stickers with a new set, when medications change significantly.

FIG. D shows some additional alternate refinements. Assume there are two or more users in the same household who desire to use the system. One method not specifically shown is the use of further letters (or numbers) for other users. Another technique may be to let them use the same numbers and background colors, but add a distinguishing difference to each sticker. This might be a variation in printing such as an underlined letter 21, an outer black ring 22 or other optional marking such as 23. It can also be a difference in the shape of the cutout such as a square 24 or an octagon 25. Line 19 (the name entry on the user profile identified in FIG. C) already provides a means of identifying separate users.

While the invention teaches to apply specific letters and colors both to the identification field of each line of the Medication Profile and the corresponding Medication Container, there is considerable leeway in arranging details of the Medication Profile 15 within the scope of the invention. Similarly stickers 9, 10, 11 and 12 and others not specifically identified can be of different size, shape or associated colors and letters, numbers or symbols arranged in any number of combinations.

Accordingly we teach an invention which provides “match” visual aids for users of multiple medications.

These aids are intended to make it easy to select their medications correctly. We have discussed the preferred embodiment as well as a number of alternate embodiments. All of these would fall within the scope and claims of this invention.

What is claimed is:

1. A medication identification system, including:
A sheet arrangement including a matrix of rows and columns on which to generate a medication profile, each of said rows to contain minimally the name of a medication and an identification field;
said sheet arrangement including a plurality of removable stickers for attachment to a medication container, said stickers each visually corresponding to one of said identification fields.

2. A medication identification system as defined in claim 1, wherein each said identification field consists of a selection of alphanumeric characters, each of said selection of alphanumeric characters on said rows is different from the other said selections on said identification fields on said rows.

3. A medication identification system as defined in claim 1, wherein each of said identification fields consists of a selection of alphanumeric characters, each of said selections of alphanumeric characters on said rows is different from the other of said identification fields on said rows; and where each of said identification fields carries a color.

4. A medication identification system as defined in claim 1, whereby each said row of information on said medication profile is visually related by its said identification field to its corresponding said sticker for attachment to said medication container.

5. A medication identification system as defined in claim 1, wherein the sheet arrangement consists of a single laminated sheet; and where said stickers are on the front face of said sheet and; where said medication profile is on the back face of said sheet.

6. A medication identification system as defined in claim 1, customized for use by more than one individual in a household;
wherein a patient name is provided on said medication profile and;
wherein additional sets of said removable stickers are provided;
and where each of said identification fields on each of said additional sticker sets carries a further identification unique to each of said additional sets.

7. A medication identification system as defined in claim 1, generated by the pharmacy computer wherein each of said stickers is made an integral part of the label of each corresponding medication.

8. A medication identification system including a sheet arrangement, said sheet arrangement including:
a matrix of rows and columns on which to generate a medication profile, each row containing minimally the name of a medication and an identification field and;
a plurality of pairs of removable stickers, each said pair including a first sticker for attachment to the medication container, and a second sticker for attachment to the removable cap of said container, said first and second stickers of each of said pair being similar to each other and distinct from the other said pairs; said pair of stickers corresponding to one of said identification fields on said medication profile;
whereby each row of information on said medication profile is visually related by its said identification field to its corresponding said sticker on said medication container and said cap of said medication container.

9. A medication identification system as defined in claim 8, where each of said pairs of stickers carries the color of said corresponding identification field on said row of said medication profile.

10. A medication identification system, including the following steps:
entering information about a plurality of medications on a plurality of rows on a medication profile; each said row dedicated to one of said medications, said rows on said medication profile each identified by a distinct identification field;
placing on the container of said medication a sticker visually corresponding to said identification field of said medication on said medication profile.

11. A medication identification system as defined in claim 10, and; placing on the cap of said medication a second sticker, from said pair of visually similar stickers.
